(19) United States
(12) Patent Application Publication
(10) Pub. No.: US 2024/0223452 A1
(43) Pub. Date: Jul. 4, 2024

(54) DATA CENTER ALTERNATE FUNCTIONALITY

(71) Applicant: SOLUTIONS HUMANITAS INC., Montreal (CA)

(72) Inventors: Abdo SHABAH, Montreal (CA); Maroua BEN ATTIA, Montreal (CA); Chuan PHAM, Montreal (CA)

(21) Appl. No.: 18/398,507

(22) Filed: Dec. 28, 2023

Related U.S. Application Data
(60) Provisional application No. 63/436,479, filed on Dec. 30, 2022.

(51) Int. Cl. H04L 41/0823; H04L 47/70

(52) U.S. Cl. CPC H04L 41/0823; H04L 47/82

(57) ABSTRACT

A method and a networked-thing, in a network of devices, providing a core functionality and an alternate functionality. While providing the core functionality using one or more non-computing-resources thereof, available computing-resources are identified that are momentarily unnecessary for the core functionality at least some computing-resources from the available computing-resources are assigned to the alternate functionality for joining membership of a scalable data center therewith. Assignment or computing-resources at the networked-thing between the core functionality and the alternate functionality is altered, thereby enhancing performance of the alternate functionality, the core functionality being independent from the alternate functionality prior to the altering.

### PRIORITY STATEMENT UNDER 35 U.S.C § 0.119 (E) & 37 C.F.R. § 0.1.78

This non-provisional patent application claims priority based upon the prior U.S. provisional patent application entitled “DATA CENTER ALTERNATE FUNCTIONALITY”, application No. 63/436,479, filed 2022 Dec. 30, in the name of Solutions Humanitas Inc., which is hereby incorporated by reference in its entirety.

### TECHNICAL FIELD

The present invention relates to resource usage enhancement and, more particularly, to resource usage enhancement between networked devices.

### BACKGROUND

Internet-of-things (IOT) provides a multitude of connected objects with varying computing capabilities. Most of the time, the capabilities of the IoT devices exceed their needs related to their primary function. The present invention explores the possibility of harvesting such exceeding capacity.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method executed at a networked-thing, in a network of devices, is suggested for providing a core functionality and an alternate functionality of the networked-thing. The method comprises, while provide the core functionality of the networked-thing using one or more non-computing-resources of the networked-thing, identifying available computing-resources of the networked-thing, momentarily unnecessary for the core functionality, the computing-resources having one or more of storage-resources of the networked-thing and processor-resources of the networked-thing. The method also comprises, while providing the core functionality of the networked-thing using one or more non-computing-resources of the networked-thing, assigning at least some computing-resources from the available computing-resources to the alternate functionality, the alternate functionality being limited to the computing-resources of the networked-thing and joining membership of the scalable data center with the computing-resources assigned to the alternate functionality, the scalable data center having one or more of the devices. Still while provide the core functionality of the networked-thing using one or more non-computing-resources of the networked-thing, the method comprises altering computing-resources assignment at the networked-thing between one or more of the core functionality and the alternate functionality, thereby enhancing performance of the alternate functionality, the core functionality being independent from the alternate functionality prior to the altering. Other embodiments of this aspect include corresponding computer systems, apparatus, and computer programs recorded on one or more computer storage devices, each configured to perform the actions of the methods.

Implementations may include one or more of the following features. The method may include negotiating the computing-resources assignment with one or more of the devices before assigning computing-resources from the available computing-resources to the alternate functionality. The method may include obtaining the computing-resources assignment from a pre-existing configuration before assigning computing-resources from the available computing-resources to the alternate functionality. Joining membership may include negotiating membership of the networked-thing into the scalable data center. The method may include negotiating capabilities of the networked-thing assignable to the alternate functionality with a plurality the one or more devices. Joining membership may include receiving a request to join the scalable data center from one or more of the devices. Joining membership may include detecting presence of the scalable data center in the network and sending a join request to one or more of the devices. The scalable data center may provide at least one of a processing function and a storage function and the processing function and the storage function may further be distributed between the devices and the networked-thing. Implementations of the described techniques may include hardware, a method or process, or a computer tangible medium.

In one general aspect, a networked-thing comprising a storage system, one or more processors, a network interface and a computing-resource assignment module. Networked-thing also having one or more processors. Thing furthermore having a network interface. Thing in addition having a computing-resource assignment module that: while providing a core functionality: identifies available computing-resources, unnecessary for the core functionality, the computing-resources having one or more of storage-resources from the storage system and processor-resources from the one or more processors; assigns at least some computing-resources from the available computing-resources to the alternate functionality; joins membership of the scalable data center with computing-resources assigned to the alternate functionality via the network interface, the scalable data center having one or more devices; and alters computing-resources assignment at the networked-thing between one or more of the core functionality and the alternate functionality, thereby enhancing performance of the alternate functionality. Other embodiments of this aspect include corresponding computer systems, apparatus, and computer programs recorded on one or more computer storage devices, each configured to perform the actions of the methods.

Implementations may include one or more of the following features. Networked-thing may also include where the computing-resource assignment module further negotiates the computing-resources assignment with one or more of the devices via the network interface before assigning computing-resources from the available computing-resources to the alternate functionality. Networked-thing may also include where the computing-resource assignment module further obtains the computing-resources assignment from a pre-existing configuration before assigning computing-resources from the available computing-resources to the alternate functionality. Networked-thing may also further may include where the computing-resource assignment module further joining membership further may include negotiating membership of the networked-thing into the scalable data center with one or more of the devices via the network interface. Networked-thing may also in addition may include where the computing-resource assignment module further negotiates capabilities of the networked-thing assignable to the alternate functionality with a plurality the one or more devices via the network interface. Networked-thing may also moreover may include where the computing-resource assignment module further joining membership further may include receiving a request to join the scalable data center from one or more of the devices via the network interface. Networked-thing may also include where the computing-resource assignment module further joining membership further may include detecting presence of the scalable data center in the network and sending a join request to one or more of the devices via the network interface. Networked-system may also further may include where the scalable data center provides at least one of a processing function and a storage function, the processing function and the function being distributed between the devices and the networked-thing. Networked-thing may also in addition may include where the scalable data center provides at least one of a processing function and a storage function, the processing function and the function being distributed between the devices and the networked-thing. Implementations of the described techniques may include hardware, a method or process, or a computer tangible medium.

In one general aspect, a networked system having one or more networked devices and a networked-thing, the networked-thing having: a storage system one or more processors; a network interface; a computing-resource assignment module that: while providing a core functionality: identifies available computing-resources, unnecessary for the core functionality, the computing-resources having one or more of storage-resources from the storage system and processor-resources from the one or more processors; assigns at least some computing-resources from the available computing-resources to the alternate functionality; joins membership of the scalable data center with computing-resources assigned to the alternate functionality via the network interface, the scalable data center having one or more of the devices; and alters computing-resources assignment at the networked-thing between one or more of the core functionality and the alternate functionality, thereby enhancing performance of the alternate functionality. Other embodiments of this aspect include corresponding computer systems, apparatus, and computer programs recorded on one or more computer storage devices, each configured to perform the actions of the methods.

### BRIEF DESCRIPTION OF THE DRAWINGS

Further features and exemplary advantages of the present invention will become apparent from the following detailed description, taken in conjunction with the appended drawings, in which:

FIG. 1 is a flow chart of an exemplary method in accordance with the teachings of the present invention;

FIG. 2 is a modular representation of an exemplary networked-thing in accordance with the teachings of the present invention;

FIGS. 3A and 3B together referred to as FIG. 3 are flow charts of an exemplary method in accordance with the teachings of the present invention; and

FIG. 4 is a modular representation of an exemplary networked-thing deployment in accordance with the teachings of the present invention.

### DETAILED DESCRIPTION

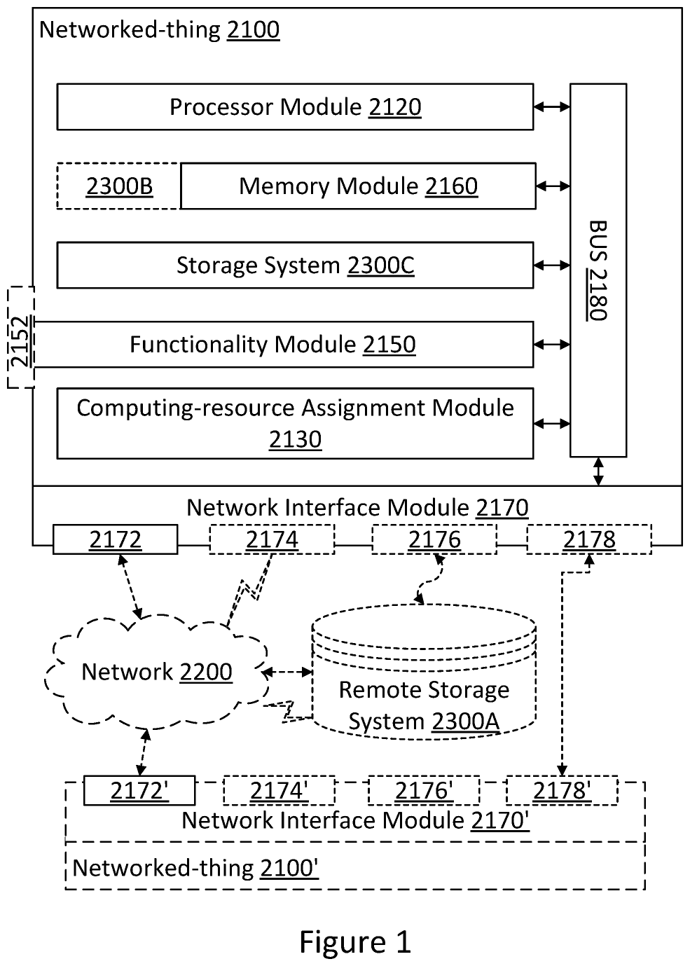

FIG. 1 shows a logical modular representation of an exemplary system 2000 comprising a networked-thing 2100. The networked-thing node 2100 comprises a memory module 2160, a processor module 2120, a user interface module (not shown), and a network interface module 2170. The system 2000 may also include a storage system 2300. The system 2000 includes a network 2200 that may be used for accessing storage system 2300 or other nodes (not shown).

The networked-thing node 2100 may comprise a storage system 2300 for storing and accessing long-term (i.e., non-transitory) data and may further log data while the innovation accelerator system is being used. FIG. 1 shows examples of the storage system 2300 as a distinct database system 2300A, a distinct module 2300C of the innovation accelerator system 2100 or a sub-module 2300B of the memory module 2160 of the innovation accelerator system 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the innovation accelerator system 2100 by a standardized or proprietary interface or via the network interface module 2170. The variants of storage system 2300 usable in the context of the present invention will be readily apparent to persons skilled in the art.

In the depicted example of FIG. 1, the distributed network node 2100 shows an optional remote storage system 2300A which may communicate through the network 2200 with the networked-thing 2100. The storage system 2300, (e.g., a networked data storage system) accessible to all modules of the networked-thing 2100 via the network interface module 2170 through a network 2200, may be used to store data. The storage system 2300 may represent one or more logical or physical as well as local or remote hard disk drive (HDD) (or an array thereof). The storage system 2300 may further represent a local 2300B, 2300C or remote database 2300A made accessible to the networked-thing 2100 by a standardized or proprietary interface. The network interface module 2170 represents at least one physical interface that can be used to communicate with other network nodes. The network interface module 2170 may be made visible to the other modules of the networked-thing 2100 through one or more logical interfaces. The actual stacks of protocols used by the physical network interface(s) and/or logical network interface(s) of the network interface module 2170 do not affect the teachings of the present invention. The variants of processor module 2120, memory module 2160, network interface module 2170 and storage system 2300 usable in the context of the present invention will be readily apparent to persons skilled in the art.

Likewise, even though explicit mentions of the memory module 2160 and/or the processor module 2120 are not made throughout the description of the present examples, persons skilled in the art will readily recognize that such modules are used in conjunction with other modules of the network node 2100 to perform routine as well as innovative steps related to the present invention.

The processor module 2120 may represent a single processor with one or more processor cores or an array of processors, each comprising one or more processor cores. The processor module 2120, may comprise one or more microprocessor and/or microcontroller. The memory module 2160 may comprise various types of memory (different standardized or kinds of Random Access Memory (RAM) modules, memory cards, Read-Only Memory (ROM) modules, programmable ROM, etc.). The network interface module 2170 represents at least one physical interface that can be used to communicate with other network nodes. The network interface module 2170 may be made visible to the other modules of the innovation accelerator system 2100 through one or more logical interfaces. The actual stacks of protocols used by the physical network interface(s) and/or logical network interface(s) 2172-2178 of the network interface module 2170 do not affect the teachings of the present invention. The variants of processor module 2120, memory module 2160 and network interface module 2170 usable in the context of the present invention will be readily apparent to persons skilled in the art. In the context of the present invention, skilled persons will recognize that a network interface may be formed by a direct connection ensuring networking capabilities.

A bus 2180 is depicted as an example of means for exchanging data between the different modules of the networked-thing 2100. The present invention is not affected by the way the different modules exchange information. For instance, the memory module 2160 and the processor module 2120 could be connected by a parallel bus, but could also be connected by a serial connection or involve an intermediate module (not shown) without affecting the teachings of the present invention.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

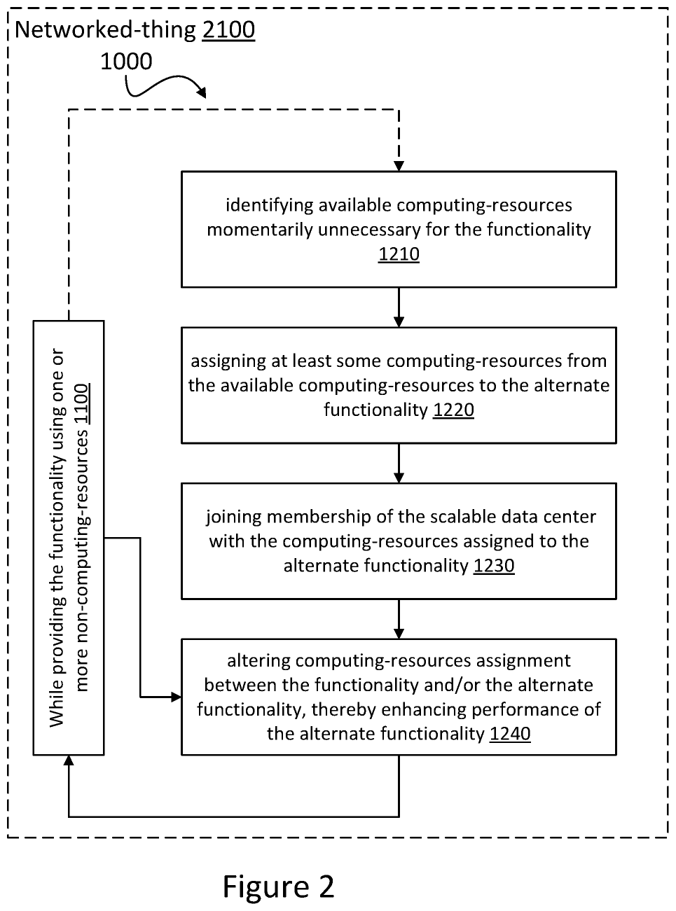

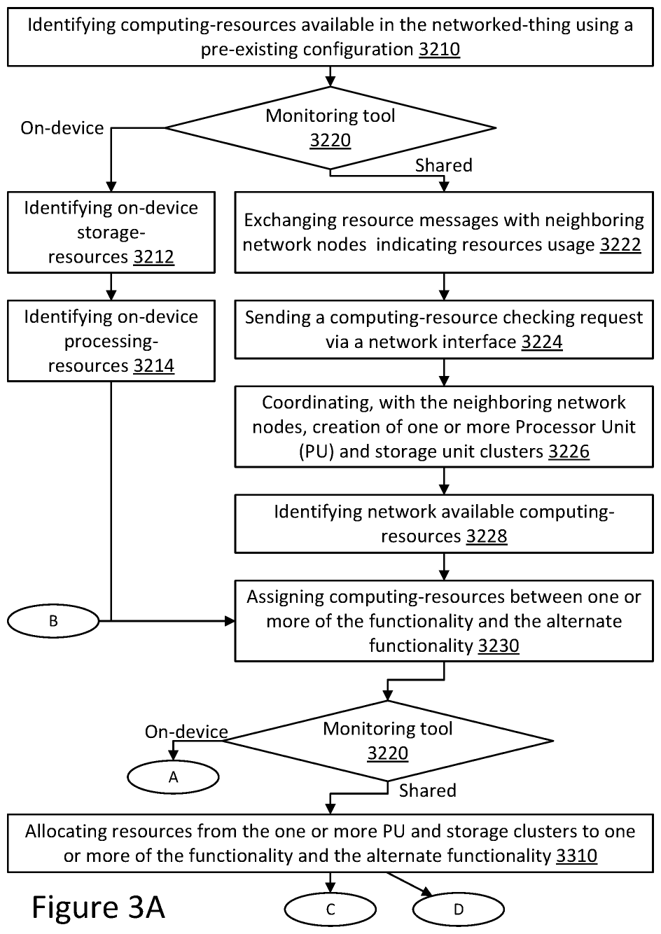

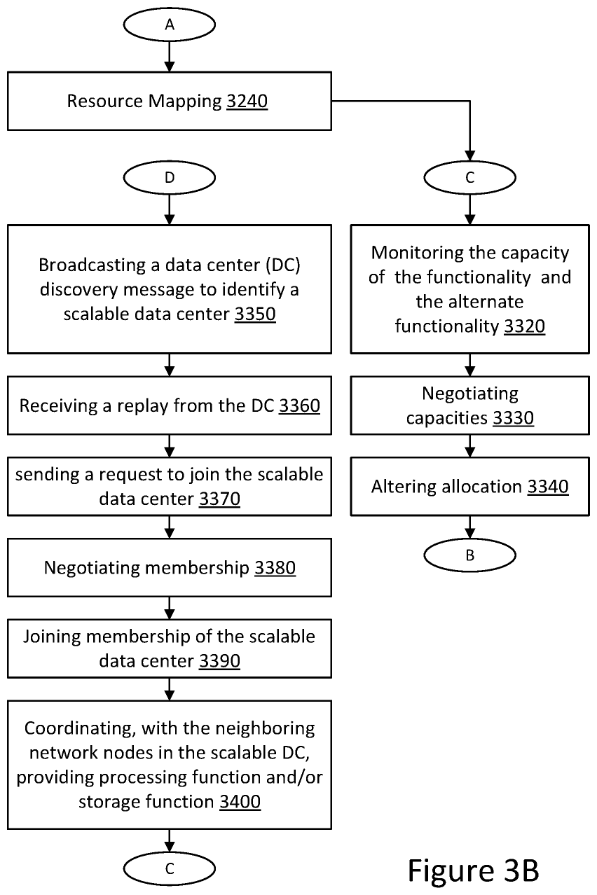

As will become apparent with particular reference to FIG. 2 and FIG. 3, a functionality module 2150 of the networked-thing 2100 provides a core functionality and an alternate functionality. The core functionality of the networked-thing 2100 requires resources from the processor module 2120 and the memory module 2160. The alternate functionality may always run or, in certain embodiments, may be triggered by an event detected at or by the networked-thing 2100. For instance, an event that may trigger an alternate functionality is a status determination made by the networked-thing 2100. A status determination may be made when entering or existing a GPS-defined area, connecting or disconnecting from the network 2200 or another network (not shown), explicitly activating the alternate functionality of the networked-thing 2100 (e.g., physical switch or logical switch (not shown) activated (not shown) locally or remotely from the networked-thing 2100, etc.). Another example of an event may be a request to join a scalable data center received from the network interface module 2170. Other exemplary events may include detecting presence of a device in the surrounding of the networked-thing 2100 (e.g., detecting any kind of electromagnetic emissions and/or identifying a specific device).

Sensors (not shown) may be provided by or with the network-thing 2100. Examples of sensors that may be used in the context of the present disclosure include Bluetooth (e.g., tracking or localization), Channel state information (CSI) via WLAN, microphone, Ultra Wide Band (UWB) localization, optical camera, thermal infrared (PIR), laser, ultrasonic or ultrasound, temperature, humidity, RFID, Time of Flight (TOF), etc.

Bluetooth tracking may be used to track humans and objects that possess a Bluetooth tag thereon. The tag may typically be tracked within a certain radius (range). CSI relying on WLAN describes how a signal propagates from the transmitter to the receiver and represents the combined effect of, for example, scattering, fading, and power decay with distance. CSI may potentially be used to describe, using machine learning, activities taking place in a room based on the signal being received. A microphone may be used, in addition to voice-related services, to sense when a noisy object or a person making noise is in a room. UWB may use one or more tags to track humans or objects in real time or close to real-time while providing predictable accuracy. As can be appreciated, a large area and/or large number of tags may slow the system (e.g., farther from true real-time) and/or decrease accuracy. Cameras may be used to identify people and/or people position, the number of people, as well as the activities taking place in a given area (e.g., using image recognition). Infrared camera or sensor may be used at night for night vision. Passive Infrared sensors may be used to detect motion or presence of moving objects (e.g., humans and animals, but only warm objects). Laser technology, e.g., as used in lidars, may be used to detect moving objects (e.g., focusing on a certain area or have rotating sensors for a 360 view). Ultrasonic/ultrasound may be used to detect objects and/or persons. Temperature and/or humidity sensors may be installed to measure the temperature of the environment (e.g., useful for automation purposes). RFID uses tags that may be used to track objects (active and/or passive). TOF sensors, may be sued in conjunction with other sensors (e.g., IR, ultrasonic, cameras) to allow distance measurements.

The alternate functionality of the networked-thing 2100 is associated with a scalable data center. The scalable data center comprises a plurality of networked devices (e.g., interconnected through the network 2200 or connected directly to one another). The scalable data center may be represented by an heterogenous or homogeneous network topology. Membership to the scalable data center may be centralized, decentralized or hybrid. In some implementations, the scalable data centre forms a standalone network of connected devices (e.g., not reliant on the internet or other similar extraneous infrastructure). The scalable data center comprises at least two networked-things similar in functionality to the network thing 2100, with at least one having a core functionality and an alternate functionality for joining the scalable data center. The scalable data center may optionally comprise one or more servers having a data center as a core server functionality. That is, the scalable data center does not necessarily comprise a dedicated server.

A networked-thing 2100′ is depicted on FIG. 1 to illustrate an example of devices that may be part of the scalable data center. Skilled persons will readily understand that the devices that are part of the scalable data center do not need to share the core functionality of the networked-thing 2100 and/or do not to provide a functionality that is similar to the core functionality of the networked-thing 2100. In fact, other devices that are part of the scalable data center may be dedicated thereto.

The core functionality of the networked-thing is provided by the functionality module, which may comprise a dedicated interface 2152. Examples of the networked-thing 2100 and associated core functionality include a networked coffee machine to make coffee, a connected refrigerator to cool an enclosed space, a connected lamp to provide lighting (e.g., lamp fixture in a building, desktop lamp, . . . ), a connected electrical switch to selectively control an extricable circuit (e.g., single pole, intelligent switch), a connected thermostat to regulate temperature, a printer to print documents or specimens (3D printer), a photocopier to copy documents, a connected vehicle to move one or more payload, a connected bicycle to move or train a person, a connected music player to play music, etc.

FIG. 2 presents a flow chart of an exemplary method 1000 executed at a networked-thing 2100, in a network 2200 of devices. The networked-thing provides a core functionality and an alternate functionality. The method 1000 is executed while providing 1100 the core functionality of the networked-thing.

The method 1000 comprises identifying 1210 available computing-resources of the networked-thing 2100, unnecessary for the core functionality, the computing-resources comprising one or more of storage-resources from the storage system 2300 and processor-resources from the processor module 2120. Identifying 1210 may be performed using a computing-resource assignment module 2130.

The method 1000 comprises assigning 1220 at least some computing-resources from the available computing-resources to the alternate functionality. Assigning 1220 may be performed using the computing-resource assignment module 2130.

The method 1000 comprises joining 1230 membership of the scalable data center with computing-resources assigned to the alternate functionality, the scalable data center comprising one or more of the devices. Joining 1230 may be performed using the computing-resource assignment module 2130.

The method 1000 comprises altering 1240 computing-resources assignment at the networked-thing 2100 between one or more of the core functionality and the alternate functionality, thereby enhancing performance of the alternate functionality. Altering 1240 may be performed using the computing-resource assignment module 2130.

The method 1000 may include additional implementations, such as any single option or any combination of options described below and/or in connection with one or more other processes described elsewhere herein. In accordance with a first option, the method 1000 may include negotiating the computing-resources assignment with one or more of the devices before assigning 1220 computing-resources from the available computing-resources to the alternate functionality.

In accordance with a second option, alone or in combination with the first implementation, the method 1000 may include obtaining the computing-resources assignment from a pre-existing configuration before assigning 1220 computing-resources from the available computing-resources to the alternate functionality.

In accordance with a third option, alone or in combination with the first and second options, joining 1230 membership may further include negotiating membership of the networked-thing into the scalable data center.

In accordance with a fourth option, alone or in combination with one or more of the first through third options, the method 1000 may include negotiating capabilities of the networked-thing assignable to the alternate functionality with a plurality the one or more devices.

In accordance with a fifth option, alone or in combination with one or more of the first through fourth options, joining 1230 membership may further include receiving a request to join the scalable data center from one or more of the devices.

In accordance with a sixth option, alone or in combination with one or more of the first through fifth options, joining 1230 membership may further include detecting presence of the scalable data center in the network and sending a join request to one or more of the devices.

In accordance with a seventh option, alone or in combination with one or more of the first through sixth options, the scalable data center provides at least one of a processing function and a storage function, the processing function and the storage function being distributed between the devices and the networked-thing.

Although FIG. 2 shows example blocks of the method 1000, in some implementations, the method 1000 may include additional blocks, fewer blocks, different blocks, or differently arranged blocks than those depicted in FIG. 1. Additionally, or alternatively, two or more of the blocks of the method 1000 may be performed in parallel.

In some embodiments, altering 1240 computing-resources assignment may be based on detected presence (from sensors affiliated to the core functionality). The alternate functionality may also take precedence in given circumstances. For instance, the altering 1240 may be triggered by an event detected at or by the networked-thing 2100 similar to the event that may have caused the alternate functionality to be triggered in the first place. For instance, an event that may trigger the altering 1240 is a status determination made by the networked-thing 2100. A status determination may be made when entering or existing a GPS-defined area, connecting or disconnecting from the network 2200 or another network (not shown), explicitly activating the alternate functionality of the networked-thing 2100 (e.g., physical switch or logical switch (not shown) activated (not shown) locally or remotely from the networked-thing 2100, etc.). Another example of an event may be a request to leave the scalable data center received from the network interface module 2170. Other exemplary events may include detecting presence of a device in the surrounding of the networked-thing 2100 (e.g., detecting any kind of electromagnetic emissions and/or identifying a specific device). In some embodiments, behavior of the core functionality may be affected by the alternate functionality. For instance, a request may be received to increase allocation of resources for the scalable data center, e.g., because the scalable data center is involved in a high priority operation (e.g., sponsored operation). Altering 2140 the computing-resources assignment may therefore be triggered by a request received by the networked-thing 2100 for that purpose. In some embodiments, the core functionality may have a threshold (e.g., floor or ceiling) resource requirement that cannot be bypassed without affecting minimal performance of the core functionality (e.g., a connected car may turn off the navigation system but not the braking system).

The example of FIG. 3 starts at the networked-thing 2100 identifying 3210 computing-resources available. This may be performed using a pre-existing configuration. The example of FIG. 3 is affected by the monitoring tool 3220 is used and the manner in which resources of the networked-thing 2100 are managed. More specifically, in the depicted example, the monitoring tool 3220 may monitor the networked-thing independently, in which case the identifying 3210 involves identifying 3212 on-device available storage-resources and identifying 3214 on-device available processing-resources. Afterwards, assigning 3230 (B) computing-resources of the networked-thing 2100 between one or more of the core functionality and the alternate functionality is performed.

The monitoring tool 3220 may alternatively or additionally monitor resources shared between devices of the network 2200 and the networked-thing 2100. In the latter case, the identifying 3210 involves exchanging 3222 resource messages with neighboring network nodes indicating resources usage, sending 3224 a computing-resource checking request via the network interface 2170, coordinating 3226, with the neighboring network nodes, creation of one or more processor unit (PU) and storage unit clusters and identifying 3228 network available computing-resources. Afterwards, assigning 3230 (B) computing-resources of the networked-thing 2100 between one or more of the core functionality and the alternate functionality is performed.

When the monitoring tool 3220 monitors the networked-thing independently, the assigning 3230 is followed (A) by mapping 3240 the resources. A subsequent discovery phase (D) starts thereafter (see below).

When the monitoring tool 3220 monitors resources shared between devices of the network 2200 and the networked-thing 2100, the assigning 3243 is followed by allocating 3310 resources from the one or more PU and storage clusters to one or more of the core functionality and the alternate functionality. Following the allocating 3310, the discovery phase (D) is performed.

The discovery phase (D) comprises broadcasting 3350 a data center (DC) discovery message to identify a scalable data center, receiving 3360 a replay from the DC (e.g., through the network interface module 2170), sending 3370 a request to join the scalable data center (e.g., through the network interface module 2170), negotiating 3380 membership to the DC, joining 3390 membership of the scalable data center in accordance with the negotiation. The discovery phase completes with coordinating 3400, with the neighboring network nodes in the scalable DC, provision of the processing function and/or storage function of the DC. The monitoring phase (C) is thereafter entered.

The monitoring phase (C) comprises monitoring 3320 the resources of the networked-thing 2100 and performance of the core functionality and the alternate functionality. Based on the monitoring 3320, negotiating 3330 capacities of the networked-thing 2100 assigned to the alternate function may take place with other devices member of the scalable data center (e.g., through the network interface 2170). Following negotiating 3330, alterations 3340 may be to the resources assignment between the core functionality and the alternate functionality. Afterwards, assigning 3230 (B) computing-resources of the networked-thing 2100 between one or more of the core functionality and the alternate functionality is performed.

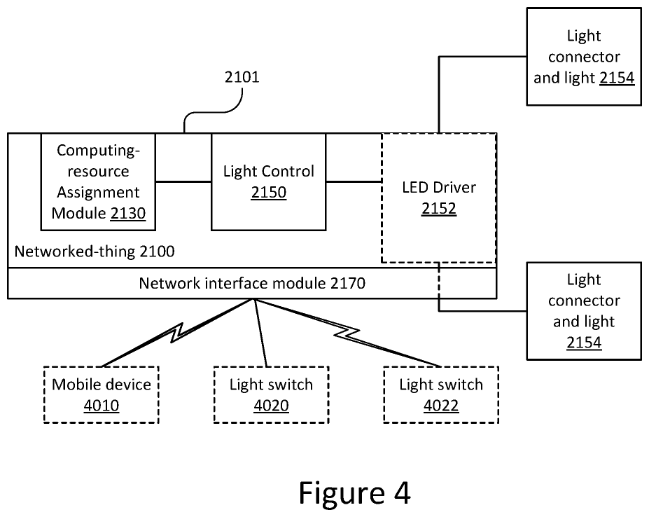

With reference to the example of FIG. 4, use of the networked-thing 2100, related methods and system as described hereinabove is depicted in the context of lighting (residential, commercial or industrial) where fluorescent lighting or similar lighting fixture would typically be used.

In the depicted example, a ballast of a fluorescent lighting fixture (e.g., troffer) is removed and replaced with an enclosure 2101 for the networked-thing 2100 (e.g., similar sized enclosure or otherwise easily attachable in lieu of the ballast). The networked-thing 2100 may then receive power from the conventional power line wiring (e.g., using a conventional AC/DC transformer) and data may be exchanged over the power lines (e.g., using IEEE Std 1901-2010 or the likes).

The one or more conventional fluorescent bulbs are replaced with non-ballast bulbs (e.g., Light Emitting Diode (LED)-based) 2154 as a part of the core functionality module 2150. The non-ballast bulbs 2154 may comprise additional light-related functions (varying colors or light temperatures; dimming; environment-friendly functions). The non-ballast bulbs 2154 and/or the networked-thing 2100 may further comprise additional elements of the network interface module 2170 such as wireless network components (e.g., Bluetooth, Bluetooth® Low Energy (Ble), WiFi™, infrared, Radio Frequency Identification (RFID), etc.), which may further act as sensors. In some cases, the networked-thing-specific functionality module(s) 2150 may be split between one or more of the non-ballast bulb and the enclosure 2101 (e.g., a led driver of the dedicated interface 2152 in the enclosure 2101 and the non-ballast bulbs 2154 outside thereof, as exemplified). Antennas for the networked-thing 2100 (not shown) may be built into one or more of the non-ballast bulbs 2154 or provided with the enclosure of the networked-thing 2100 (e.g., therewithin, connected thereto and/or attached within or on the light fixture). Different forms and types of antennas can be used including but not limited to loop, rod, telescoping, and strip.

In some other implementations, a ballast of a fluorescent lighting fixture (e.g., troffer) may be left in place and the networked-thing 2100 may then be added to (e.g., besides, on or within) the lighting fixture. The enclosure 2101 may therefore be shaped (not shown) considering remaining space of an existing lighting fixture and/or lighting fixture installation location. The networked-thing 2100 may receive power from the conventional power line wiring (e.g., connected prior to the ballast) and data may be exchanged over the power lines (e.g., using IEEE Std 1901-2010 or the likes). Alternatively, or additionally, the networked-thing 2100 may be modified to receive power selectively or solely from the modulated power lines (e.g., connected after the ballast) and data may then be exchanged using a wireless interface (e.g., Bluetooth, Bluetooth® Low Energy (Ble), WiFi™, infrared, Radio Frequency Identification (RFID), etc.). For the data to be additionally or alternatively exchanged over the modulated power lines, an additional interconnecting communication module (not shown) may be required between the power lines and the modulated power lines.

Conventional ballast bulbs or bulbs made to be compatible with the ballast (e.g., Light Emitting Diode (LED)-based) may be used in 2154. Antennas for the networked-thing 2100 may be provided with the enclosure 2101 of the networked-thing 2100 (e.g., therewithin and/or connected thereto and attached within or on the light fixture). Different forms and types of antennas can be used including but not limited to loop, rod, telescoping, and strip.

When a ballast is required for lighting operations, then an independent Power Line Communication (PLC) module (not shown) and/or a PLC module integrated in the network interface module 2170 may be provided before the ballast. The PLC module may extract the data from the power line and send it to the networked-thing 2100 (e.g., using an additional cable and/or using a wireless protocol and/or using the modulated power lines), bypassing the ballast.

The cable can be a data-only cable, or can be a data and power cable that may also power the networked-thing 2100, whereas the blast bulb may still be powered through the ballast.

The networked-thing 2100 may be provided solely within a light tube (not shown). Power for the networked-thing 2100 would be received at the bulb's terminal (modulated power lines or power lines). The networked-thing 2100 may be provided solely within a non-lighting tube that fits the expected position of a light bulb. For instance, when a lighting fixture (e.g., a troffer) comprises two or more expected positions for light bulbs, the other position(s) may be fitted with light bulbs (e.g., with lighting power emitted thereby being additionally, alternatively or selectively adjusted for the missing light source). As an additional option, the networked-thing 2100 may provide (not shown) as or with an adapter (or power grabber) fitted over one or both ends of a conventional tube, between the lighting fixture terminals and the conventional tube terminals (e.g., thin interconnector(s) shaped as a cap). Furthermore, even if reference is made to tubes, skilled persons will readily recognize that other shapes or forms may be used, including square, rectangular, or U shaped, that contains the lights and/or the networked-thing 2100.

The networked-thing 2100 may also be enhanced with a light control module of the functionality module 2150, e.g., configured to control a light dimmer/controller. A mobile device 4010, a wired light switch 4020 and/or a wireless light switch 4022 may be connected directly or indirectly to the networked-thing 2100 and may further manage the lighting functions therethrough.

More than one network-thing 2100 may be provided in a single deployment. For instance, a light switch 4020/4022 may be replaced with or be enhanced with a first networked-thing 2100′ and the network thing 2100 may be provided (as exemplified) in a light fixture. Both networked-thing 2100′ and 2100 may work independently or together.

The networked-thing 2100′ may instruct the network-thing 2100 to switch the lights while maintaining the power connection (and possibly the communication over power line communication) therebetween.

The network-thing 2100 positioned in the light fixture may also be replaced with one or more of the functionality module(s) 2150′ of the network thing 2100′ positioned in or at the light switch 4020/4022. Communication therebetween may then happen through wired (e.g., PLC/ethernet) and/or through wireless communication (e.g., WiFi).

Skilled persons will understand that the functionality modules 2150′ of the network thing 2100′ positioned in or at the light switch 4020/4022 may be distributed to more than one location. For instance, each module may be replicated multiple times in one or more of the light fixtures. Alternatively or additionally, each module may be implemented in a single one (or a single one at a time) of the one or more of the light fixtures. Furthermore, certain specific modules may be replicated multiple times (e.g., antennas) while others (e.g., hygrometer) is implemented in one of the one or more of the light fixtures

In certain implementations, multiple electric circuits may be isolated from one another (e.g., connected to different circuit beaker in a distribution panel). Likewise, more than one voltage may be made available in a premise (e.g., in North America where 110V and 220V are available for different pieces of equipment). The network-thing 2100 may be compatible with one ore many different voltages in certain examples. Furthermore, a wired or wireless channel may be established between different circuits and/or between circuits of different voltages so than a PLC module is able to communicate as if only a single circuit was present. When a single neutral line is provided, it may be used as a basis to establish a wired channel.

Skilled persons will readily recognize that other functions apart from the scalable data center may be provisioned by the networked-thing 2100 without departing from the teachings provided herein (e.g., internet access point or range extender).

The second example may also be adapted to function in the context of a electric vehicle charger in which modulated power may be provided to a car charger. As such, more than one PLC modules may be deployed to ensure communication towards the network-thing 2100 and/or between different network-things 2100, 2100′

A third example is integration of the network-things 2100 in an alternate small scale power generation unit such as solar panels, wind turbines, microhydro turbines, micro tidal generators, microbial fuel cells, ground heat pumps or the likes.

The alternate small scale power generation unit may be installed to directly power the networked-thing 2100. Additionally or alternatively, the alternate small scale power generation unit may be managed through a battery management system (BMS) to charge a battery, which may then power the networked-thing 2100 (e.g., advantageous for low light/low wind/low current situations). A battery can either be integrated with the networked-thing 2100 or provided separately (e.g., deep cycle battery and/or rechargeable battery). Additional energy management functions may be implemented in the networked-thing 2100 (e.g., power distribution and/or conversion rates, grid hookup compensation, . . . ), which may then further take into account external factors (exterior temperature; grid status (outages); time of day, . . . ).

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method executed at a networked-thing, in a network of devices, for providing a core functionality and an alternate functionality, the method comprising:
while providing the core functionality of the networked-thing using one or more non-computing-resources of the networked-thing:
identifying available computing-resources of the networked-thing, momentarily unnecessary for the core functionality, the computing-resources comprising one or more of storage-resources of the networked-thing and processor-resources of the networked-thing;
assigning at least some computing-resources from the available computing-resources to the alternate functionality, the alternate functionality being limited to the computing-resources of the networked-thing;
joining membership of the scalable data center with the computing-resources assigned to the alternate functionality, the scalable data center comprising one or more of the devices; and
altering computing-resources assignment at the networked-thing between one or more of the core functionality and the alternate functionality, thereby enhancing performance of the alternate functionality, the core functionality being independent from the alternate functionality prior to the altering.

2. The method of claim 1, further comprising negotiating the computing-resources assignment with one or more of the devices before assigning computing-resources from the available computing-resources to the alternate functionality.

3. The method of claim 1, further comprising obtaining the computing-resources assignment from a pre-existing configuration before assigning computing-resources from the available computing-resources to the alternate functionality.

4. The method of claim 1, wherein joining membership further comprises negotiating membership of the networked-thing into the scalable data center.

5. The method of claim 4, further comprising negotiating capabilities of the networked-thing assignable to the alternate functionality with a plurality the one or more devices.

6. The method of claim 4, wherein joining membership further comprises receiving a request to join the scalable data center from one or more of the devices.

7. The method of claim 4, wherein joining membership further comprises detecting presence of the scalable data center in the network and sending a join request to one or more of the devices.

8. The method of claim 1, wherein the scalable data center provides at least one of a processing function and a storage function, the processing function and the storage function being distributed between the devices and the networked-thing.
A networked-thing comprising:
a storage system;
one or more processors;
a network interface; and
a computing-resource assignment module that:
while providing a core functionality:
identifies available computing-resources, unnecessary for the core functionality, the computing-resources comprising one or more of storage-resources from the storage system and processor-resources from the one or more processors;
assigns at least some computing-resources from the available computing-resources to an alternate functionality;
joins membership of a scalable data center with computing-resources assigned to the alternate functionality via the network interface, the scalable data center comprising one or more devices; and
alters computing-resources assignment at the networked-thing between one or more of the core functionality and the alternate functionality, thereby enhancing performance of the alternate functionality.

9. The networked-thing of claim 9, wherein the computing-resource assignment module further negotiates the computing-resources assignment with one or more of the devices via the network interface before assigning computing-resources from the available computing-resources to the alternate functionality.

10. The networked-thing of claim 9, wherein the computing-resource assignment module further obtains the computing-resources assignment from a pre-existing configuration before assigning computing-resources from the available computing-resources to the alternate functionality.

11. The networked-thing of claim 9, wherein the computing-resource assignment module further joining membership further comprises negotiating membership of the networked-thing into the scalable data center with one or more of the devices via the network interface.

12. The networked-thing of claim 12, wherein the computing-resource assignment module further negotiates capabilities of the networked-thing assignable to the alternate functionality with a plurality the one or more devices via the network interface.

13. The networked-thing of claim 12, wherein the computing-resource assignment module further joining membership further comprises receiving a request to join the scalable data center from one or more of the devices via the network interface.

14. The networked-thing of claim 12, wherein the computing-resource assignment module further joining membership further comprises detecting presence of the scalable data center in the network and sending a join request to one or more of the devices via the network interface.

15. The networked-thing of claim 9, wherein the scalable data center provides at least one of a processing function and a storage function, the processing function and the function being distributed between the devices and the networked-thing.

16. A networked system comprising:
one or more networked devices and a networked-thing, the networked-thing comprising:
a storage system;
one or more processors;
a network interface;
a computing-resource assignment configured to:
while providing a core functionality:
identify available computing-resources, unnecessary for the core functionality, the computing-resources comprising one or more of storage-resources from the storage system and processor-resources from the one or more processors;
assign at least some computing-resources from the available computing-resources to an alternate functionality;
join membership of a scalable data center with computing-resources assigned to the alternate functionality via the network interface, the scalable data center comprising one or more of the devices; and
alter computing-resources assignment at the networked-thing between one or more of the core functionality and the alternate functionality, thereby enhancing performance of the alternate functionality.

17. The networked system of claim 17, wherein the scalable data center provides at least one of a processing function and a storage function, the processing function and the function being distributed between the devices and the networked-thing.
